(19) United States
(12) Patent Application Publication
(10) Pub. No.: US 2024/0128837 A1
(43) Pub. Date: Apr. 18, 2024

(54) Chargers and DC-DC Converters Integrated with a Poly-Phase Motor Drive

(71) Applicants: Hengchun Mao, Allen, TX (US); Xuezhong Jia, Allen, TX (US)

(72) Inventors: Hengchun Mao, Allen, TX (US); Xuezhong Jia, Allen, TX (US)

(21) Appl. No.: 18/380,157

(22) Filed: Oct. 13, 2023

Related U.S. Application Data
(60) Provisional application No. 63/416,555, filed on Oct. 16, 2022.

(51) Int. Cl. H02K 11/33; H02K 1/12; H02M 3/335

(52) U.S. Cl. CPC H02K 11/33; H02K 1/12; H02M 3/335; H02M 1/42

(57) ABSTRACT

A device includes a plurality of phase legs configured to be coupled to a motor and arranged into at least two groups. Each group has more than one phase leg, and each phase leg has at least two power switches coupled between a positive dc rail and a negative dc rail of the group. The motor has a stator and a rotor configured to be magnetically coupled through an air gap and a plurality of phase windings distributed along a perimeter of the stator. Each of the plurality of phase windings is coupled to one of the plurality of phase legs. The device also has a first dc link switch placed between the dc rails of a group and the dc rails of another group, and a controller configured to close the first dc link switch for the device to operate in a motor drive mode, or open the dc link switch for the device to operate in a power conversion mode.

### CROSS REFERENCE TO RELATED APPLICATIONS

This application claims priority to U.S. Provisional Application No. 63/416,555, filed on Oct. 16, 2022, entitled “Novel Chargers and DC-DC Converters Integrated with a Poly-Phase Motor Drives”, which is herein incorporated by reference.

### TECHNICAL FIELD

The present disclosure relates to chargers and dc-dc power converters integrated with poly-phase motor drives, and, in particular embodiments, to innovative technologies which improve the design, construction and manufacturing of chargers and dc-dc power converters through utilizing components and parts of the motor and inverter in a poly-phase motor drive system.

### BACKGROUND

A poly-phase electric machine (motor or generator) is an apparatus converting energy between electric power and mechanical motion with more than three phase windings. For example, a 6-phase motor has 6 phase windings, and a 9-phase motor has 9 phase windings. There are different types of electric machines including induction machines, electrically excited synchronous motors, permanent magnets machines, switching reluctance machines, synchronous reluctance machines and hybrid machines etc. The various embodiments in this disclosure are applicable to these different types of electric machines, which can be used as either motors or generators. Motors as an example are used to illustrate the innovative aspects of the present disclosure, but the innovative technologies in this disclosure are also applicable to generators. A motor usually comprises a stator and a rotor, although it may contains multiple stators or multiple rotors. The stator is the stationary part and the rotor is the rotating part. The rotor may be inside the stator, outside the stator or beside the stator as in an axial field machine or a linear machine. A motor having a rotor inside a stator is used as an example to illustrate the innovative aspects of the present disclosure. A small air gap exists between the rotor and the stator for mechanical clearance and mechanical torque generation.

The phase windings are located in the stator along the air gap. In operation, electric power is usually applied to the stator, or more exactly, to the phase windings. The electric power is controlled by a power converter, usually an inverter when the motor is an ac (alternating current) motor. The motor and its coupled power converter as a whole is called a motor drive or a motor drive system. As size, weight and cost become increasingly important in demanding applications such as in electric or hybrid vehicles, generator sets or wind turbines, it is desirable to integrate more functions into the motor drive system. For example, in EV or other applications, all or part of the inverter and/or motor can be reused in the battery charger or in a dc-dc converter. However, in traditional 3-phase system such reuse of the inverter and motor has significant limitation, and usually results in lower performance.

### SUMMARY

These and other problems are generally solved or circumvented, and technical advantages are generally achieved, by preferred embodiments of the present disclosure which provide novel ways to reconfigure the inverter and/or the motor to perform power conversion functions as required in battery charging or dc-dc converter. The availability of high number of phase windings (and thus inverter legs) in a poly-phase motor drive gives more freedom to the reconfiguration to achieve required performance and has advantages in weight, size, cooling and cost of the system.

According to an embodiment of the present disclosure, a device includes a plurality of phase legs configured to be coupled to a motor and arranged into at least two groups. Each group has more than one phase leg, and each phase leg has at least two power switches coupled between a positive dc rail and a negative dc rail of the group. The motor has a stator and a rotor configured to be magnetically coupled through an air gap and a plurality of phase windings distributed along a perimeter of the stator. Each of the plurality of phase windings is coupled to one of the plurality of phase legs. The device also has a first dc link switch placed between the dc rails of a group and the dc rails of another group, and a controller configured to close the first dc link switch for the device to operate in a motor drive mode, or open the dc link switch for the device to operate in a power conversion mode.

According to another embodiment of the present disclosure, a method includes configuring a stator and a rotor of a motor to be magnetically coupled through an air gap, distributing a plurality of phase windings along a perimeter of the stator, and arranging a plurality of phase legs of an inverter into at least two groups, where each group has more than one phase leg, and each phase leg has at least two power switches coupled between a positive dc rail and a negative dc rail of the group and is configured to be coupled to one of the plurality of phase windings. The method also include placing a first dc link switch between the dc rails of a group and the dc rails of another group, and configuring a controller to close the first dc link switch for the motor and the inverter to operate in a motor drive mode, or open the first dc link switch for the motor and the inverter to operate in a power conversion mode.

According to yet another embodiment of the present disclosure, a system includes a motor having a stator and a rotor configured to be magnetically coupled through an air gap, and a plurality of phase windings distributed along a perimeter of the stator. The system also has a plurality of phase legs arranged into at least two groups, where each group has more than one phase leg, and each phase leg has at least two power switches coupled between a positive dc rail and a negative dc rail of the group and coupled also to one of plurality of the phase windings. The system further includes a first dc link switch placed between the dc rails of a group and the dc rails of another group, and a controller configured to close the first dc link switch for the system to operate in a motor drive mode, or open the first dc link switch for the system to operate in a power conversion mode.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of a poly-phase motor drive system in accordance with various embodiments of the present disclosure;

FIG. 2 illustrates a block diagram of the motor drive system shown in FIG. 1 giving details of inverter reconfiguration in accordance with various embodiments of the present disclosure;

FIG. 3 illustrates a configuration of the motor drive system shown in FIG. 2 in a power conversion mode in accordance with various embodiments of the present disclosure;

FIG. 4 illustrates another configuration of the motor drive system shown in FIG. 2 in a power conversion mode in accordance with various embodiments of the present disclosure;

FIG. 5 illustrates an example of reconfiguring a phase leg of an inverter in accordance with various embodiments of the present disclosure;

FIG. 6 illustrates an example of a motor drive system configured to perform non-isolated dc-dc power conversion in accordance with various embodiments of the present disclosure;

FIG. 7 illustrates an example of a motor drive system configured to perform isolated dc-dc power conversion in accordance with various embodiments of the present disclosure;

FIG. 8 illustrates an example of configuring a motor drive system in accordance with various embodiments of the present disclosure;

FIG. 9 illustrates a block diagram of a multi-ratio switched-capacitor converter in accordance with various embodiments of the present disclosure;

FIG. 10 illustrates a block diagram of a dc-dc power converter with a multi-rationswitched-capacitor converter and a buck-boost converter in accordance with various embodiments of the present disclosure;

FIG. 11 illustrates a block diagram of a battery charger in accordance with various embodiments of the present disclosure;

FIG. 12 illustrates a block diagram of another battery charger in accordance with various embodiments of the present disclosure;

FIG. 13 illustrates a block diagram of an isolated dc-dc power converter with reconfiguration of secondary windings in accordance with various embodiments of the present disclosure;

FIG. 14 illustrates a block diagram of another isolated dc-dc power converter with reconfiguration of secondary windings in accordance with various embodiments of the present disclosure;

FIG. 15 illustrates a block diagram of yet another isolated dc-dc power converter with reconfiguration of secondary windings in accordance with various embodiments of the present disclosure;

FIG. 16 illustrates a block diagram of yet another isolated dc-dc power converter with reconfiguration of secondary windings in accordance with various embodiments of the present disclosure;

FIG. 17 illustrates a block diagram of a reconfigurable battery charging system in accordance with various embodiments of the present disclosure; and

FIG. 18 illustrates block diagram of another reconfigurable battery charging system in accordance with various embodiments of the present disclosure;

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure will be described with respect to preferred embodiments in a specific context. There are different variations which may use the inventions in this disclosure to improve the design, control and manufacturing of motor drives and power conversion equipment. Hereinafter, various embodiments will be explained in detail with reference to the accompanying drawings.

With the wide-spread adoption of modern equipment such as electric vehicles (EVs) and wind power, more and more motor drives with power electronics equipment (such as inverters) are coupled to batteries or other energy sources. As a motor is actually an inductive device with a plurality of windings, there is a long desire to reconfigure the motor and its associated power electronics converter (collectively a motor drive) for other power conversion. This disclosure will present novel techniques to reconfigure a poly-phase motor drive to operate as a dc-dc power converter or ac-dc converter, with the power switches reused, and the motor windings repurposed as inductors or transformers. In this way, significant cost, size, and weight can be saved for battery charging and other power conversion applications.

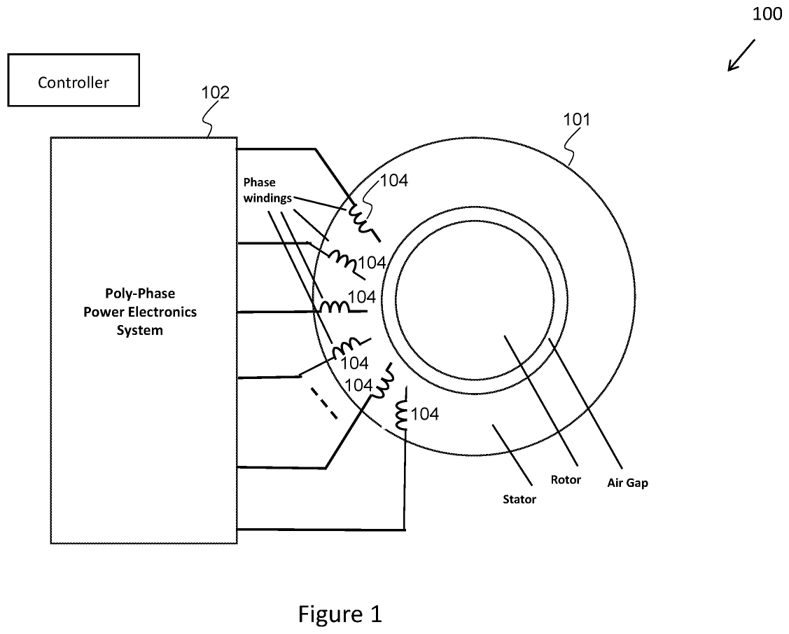

FIG. 1 shows a typical poly-phase motor drive system 100. The poly-phase motor (and/or generator, hereinafter motor) 101 has a stator, a rotor and an air gap between them, and has multiple phase windings 104 (also simply called winding. In this disclosure, each phase has one wingding, which is thus called a phase winding). In a poly-phase motor, the number of windings is higher than 3, usually 6, 9, 15 or 24, etc. Phe poly-phase power electronics system powering the motor sometimes is called an inverter, a power converter or a power conditioner (hereinafter inverter or power inverter), and consists of multiple legs, where each leg has multiple power switches coupled between a positive dc rail and a negative dc rail (usually a leg has 2 power switches). Each winding is coupled to one leg of the inverter and connected to the output of the leg, which is thus called a phase leg. The motor and the inverter may be configured such that the motor operates with different number of poles in different operation modes through a technology such as dynamically reconfigurable motor in the motor drive mode. All phase windings 104 of the motor 101 may be divided into several winding groups coupled to associated inverter groups, and each group forms a symmetric multi-phase (such as 3-phase) subsystem which has a dc output power and dc input power in steady-state operation. Different groups of the inverters may also be connected to different dc links and input power sources. The division of inverter, windings and dc link into different groups was presented in U.S. patent Ser. No. 10/541,635 and related documents.

When the motor is not used for motor drive functions, the power inverter and the motor are usually in an idle mode. It is advantageous to reconfigure the idled motor and/or the power inverter for other purposes such as charging a battery, providing or converting power adequate for an operation of a load, heating up or conditioning a battery, etc, in a power conversion mode. This helps to reduce the size, weight and cost of the system. The motor drive system can be configured to work in two modes with two configurations: in one configuration (motor drive configuration), the motor drive system 100 performs normal motor drive functions in a motor drive mode; In the other configuration (power conversion configuration), the motor drive system 100 becomes or is part of a power conversion system, and performs power conversion functions such as dc-dc voltage conversion or battery charging in a power conversion mode. In the motor drive mode, the inverter is in normal configuration, usually with all phase legs connected together. When performing such power conversion functions, the inverter and/or the motor will be in a different configuration but it is desirable that the change in the motor and the power inverter is minimized so that the cost and performance (such as power efficiency in motor drive mode and special operation mode) of the system can be optimized. The controller controls the inverter 102 and the motor 101 to perform required functions in the motor drive mode and power conversion mode, including the change of configurations (reconfiguration). In traditional three-phase systems, only three phase windings and three inverter legs are available, which limits the freedom of reconfiguration and also results in lower performance. This disclosure will present innovative techniques to achieve high performance of the reconfigured system.

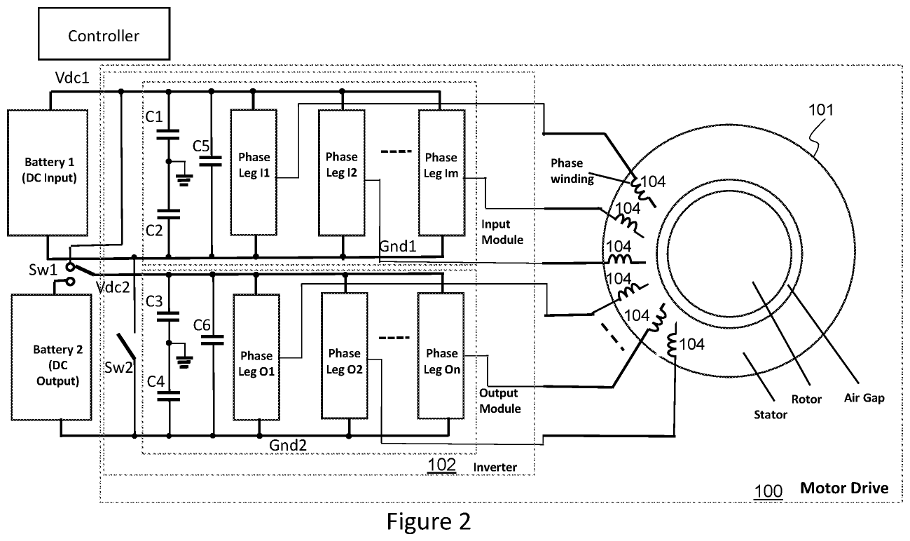

FIG. 2 shows a block diagram of a polyphase motor drive which can be configured to operate as a dc-dc power converter in the power conversion mode, with more details than FIG. 1. The phase legs with their associated dc rails in the inverter may be divided by dc link switches (represented by SW1 and SW2 in the drawing) into two or more groups. For example Phase Legs I1 through Im forms one group with positive dc rail Vdc1 and negative dc rail Gnd1, and Phase Legs O1 through On forms another group with positive dc rail Vdc2 and negative dc rail Gnd2. Each group has a positive dc rail and a negative dc rail, which are collectively called dc rails of the group. All phase legs in a group are coupled between the dc rails of the group. In FIG. 2, in motor drive mode (configuration), the dc link switches SW1 and SW2 are closed, so all inverter phase legs are connected together as in a normal power inverter. In power conversion mode, SW1 and SW2 are open so the inverter 102 is divided into two groups: one called Input Module consisting Phase Leg I1 through Phase Leg Im together with optional dc link capacitor C5 and optional EMI capacitors C1 and C2 (m is an integer usually no less than 3 and represents the number of phase legs in the Input Module), the other called Output Module consisting Phase Leg O1 through Phase Leg On (n is also an integer, usually no less than 3 and represents number of phase legs in the Output Module, which may be or may not be equal to m), together with optional dc link capacitor C6 and optional EMI capacitors C3 and C4. Each phase leg is connected to a phase winding 104 in the stator of motor 101. One dc link switch (SW1) connects or separates the positive DC rails Vdc1 and Vdc2 according to its state, and the other dc link switch (SW2) connects or separates the negative rails Gnd1 and Gnd2 similarly. Other connecting method for the SW1 and SW2 is also feasible if for power sources for the two groups are arranged differently, for example being put in series, in order to connect or separating the dc rails of the two groups.

SW1 and SW2 can be controlled according to whether the motor drive system is to be operate in the motor drive mode or the power conversion mode. Here one of the switches SW1 and SW2 may be optional. For example, if SW2 is not present, the negative dc rails Gnd1 and Gnd2 may be shorted together to have one common negative dc rail. When SW1 connects the positive dc rails Vdc1 and Vdc2 together, (and SW2 if any, are closed so GND1 and GND2 are shorted), the drive system 100 performs as a normal motor drive. Please note that EMI filter, represented by C1 through C4 which are all optional, may be distributed into two or more groups if needed. When SW1 connects dc rail Vdc2 to the dc output (that may be Battery 2 which is separated from Vdc1, while Vdc1 is the dc input which may be a battery called Battery 1), the two dc rails may be connected to different dc ports such as different batteries, so the drive system 100 may operates as a dc-dc power converter in power conversion mode. SW2 may be open so GND1 and GND2 may become separated. In this power conversion mode, the first group of phases legs called an Input Module may convert the electric power in battery 1 or dc input to suitable currents in the windings coupled to the Input Module (the input windings). The second group of phases legs called an Output Module may convert the electric power in the motor to energy in battery 2 or the dc output through controlling the currents in the windings coupled to the Output Module (the output windings)

The currents in the input windings and the output windings may be of a dc waveform in a steady-state operation, and in such a case the input windings and the output windings may be electrically connected together (as in a Y-connected motor winding systems). In this case, the dc-dc converter is non-isolated, and SW2 may be replaced by a short connection so GND1 and GND2 become one. Alternatively, the currents in the input windings may be controlled by the Input Module to be in an ac waveform with a proper phase shift and form a balanced multi-phase systems, and the input windings may be symmetrically located within the stator such that a rotating magnetic field is established in the motor by these currents. This rotating magnetic field is controlled to transfer energy efficiently to the output windings, which may be so configured and the Output Module may be controlled such that a rotating magnetic field is also established by their currents which may form a balanced multi-phase system. In this case, the input windings and the output windings may be electrically isolated, and the switch SW2 may be open so input and the output of the dc-dc power converter may be isolated. The are different ways to select and arrange the phase windings to be balanced symmetric multi-phase systems. For example, in a 9-phase motor, Phases 1, 3, 5, 7 and 9 may form a balanced multi-phase system in one group, while Phases 2, 4, 6, and 8 may form another balanced multi-phase system in another group. Alternatively, Phases 1, 4, and 7 may form a balanced multi-phase system in one group, while Phases 2, 3, 5, 6, 8 and 9 may form another balanced multi-phase system in another group, with Phases 1, 5, and 8 forming a balanced multi-phase subsystem and Phases 3, 6, and 9 forming another balanced multi-phase subsystem. The rotating speed of the rotating magnetic field is determined by the frequency of the ac currents in the windings, and can affect the power loss in the motor and the inverter. Therefore, it is preferred that the rotating speed is selected to reduce the power loss to a minimum. The input windings and the output windings may be connected together in motor drive mode, and separated in power conversion mode by opening a winding separation switch connecting these two groups of windings. Otherwise, the input windings and the output windings may also be separated in motor drive mode (i.e. the inverter 102 has two different input power sources, which may be isolated from each other, or may be in series), so no winding separation switch is needed.

The inverter can be configured to control the winding currents properly in the motor drive mode considering the separation of winding groups. In power conversion mode, a dq frame common to both the currents/voltages of the input windings and the voltages/currents of the output windings may be used in the controller to control the phase legs. As discussed earlier, the frequency of the ac currents in the windings can be selected to optimize a performance index such as power loss of the system. The frequency of the ac currents, as well as the switching frequency of the phase legs, may be made adaptive to the operating conditions (such as voltages, currents, and power) of the system to further improve such performance. Please note that Battery 1 (dc input) and Battery 2 (dc output) may be in the same equipment or different equipment, for example in different vehicles. One or more switching devices such as a power switch, a relay, or a contactor may be used to switch in or out a dc power if needed. Please also note that in power conversion mode the system can perform bucking, boosting or buck-boost functions, and the power flow can be bidirectional. Please also note that switching frequency in power conversion mode may be different from the switching frequency in the motor drive mode. SW1 and/or SW2 may be inside or outside the inverter 102 or motor drive system 100, and may be implemented as relays, contactors, MOSFETs, IGBTs or any suitable mechanic or electronics switches.

Although FIG. 2 shows an example of using dc link switches to separate the dc link into 2 sections of dc rails with associated inverter legs into 2 groups, it is also within the scope of this disclosure to separate the dc link into more sections of dc rails through using more sets of dc link switches, each set coupled to a group of inverter legs and phase windings. To reduce the power losses of the dc link switches, it is better that each group of inverter legs and phase windings forms a symmetric multi-phase system in the motor drive configuration, so that the currents flowing through the dc link switches are dc without low-frequency ac components in steady state. For example, a 9-phase drive system may be divided into 3 groups, each having 3 phase windings separated with 120° in space and currents in these phases windings are controlled by the controller to have 120° phase shift between them in motor drive configuration. Of course, a group may also have more than one set of symmetric sub groups. For example, the 9-phase drive system may be divided into two groups, one having 3 phase windings, while the other having 6-phase windings consisting of two 3-phase subgroups where each three-phase subgroup form a symmetric 3-phase system in the motor drive configuration. As both the Input Module and the Output Module have multiple phase legs, in power conversion mode the phase legs in a module may operate in interleaved fashion with a phase shift between switching actions, so both the input port and output port may see very low current ripple, while very high power can be processed, further improving the performance in the power conversion figuration (or equivalently, in power conversion mode of operation).

In addition, although the active power converter in power conversion mode has buck-boost capability, it may operate only as a buck or boost converter in an application, so the dc link switches only needs to block voltage in one direction. This makes it easier to implement these switches as uni-directional semiconductor switches which stand voltage in just one direction, such as MOSFETs or IGBTs, further reducing the cost and the power loss.

Although any type of motor may be used in the motor drive system, if a rotating magnetic field within the motor is established in the power conversion mode to facilitate isolated power conversion, different motors may have different characteristics. For example, if motor 101 is an electrically excited synchronous motor or wound rotor induction motor, there are a plurality of wound windings in the rotor. The wound windings on the rotor would conduct currents in the motor drive mode, but may be configured to conduct no current in the power conversion mode, such as being effectively in an open circuit state or having a diodes or equivalent component to block current, the rotor may not rotate even if a rotating magnetic field is established by currents in the stator windings during a power conversion mode, avoiding causing interference with the motor's load nor mechanical loss. This may be an attractive feature, and can be used advantageously to provide isolated power conversion with high efficiency in the power conversion mode.

FIG. 2 illustrates the basic concept of reconfiguring a polyphase motor drive for power conversion. As the motor drive configuration is the same as a normal motor drive and well known in the industry, following discussion will be focused on the power conversion configuration and power conversion mode of operation for various applications.

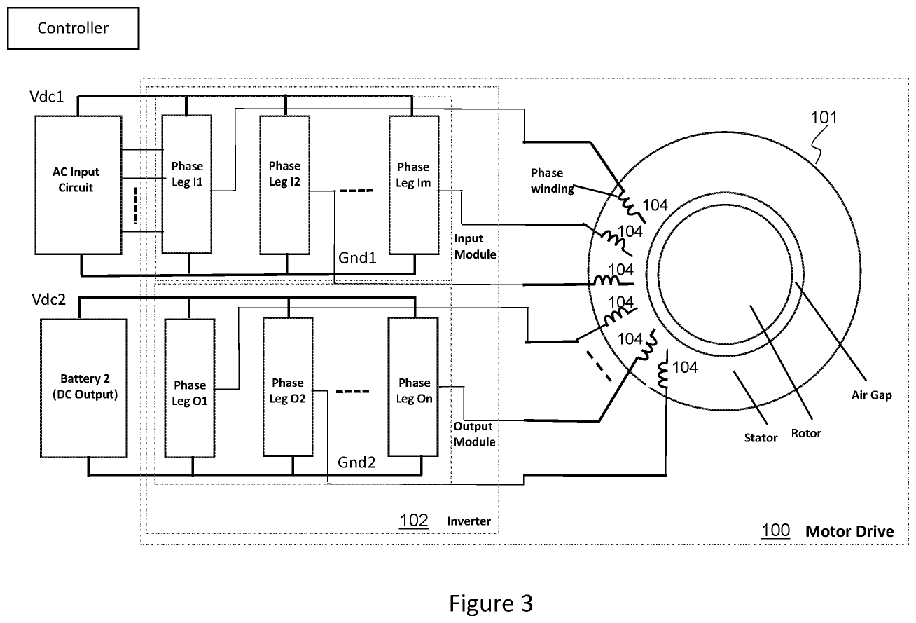

When a power/energy source in the power conversion mode is ac, the block diagram in FIG. 3 may be used. In FIG. 3 an AC Input Circuit is used to couple the system's ac input to dc rails Vdc1 and Gnd1 through the Input Module. Otherwise, the configuration of FIG. 3 is similar to that of FIG. 2, so many detailed features are omitted for the sake of brevity. The AC Input Circuit may be single phase, three phase or in other configuration. The AC Input Circuit may have an emi filter, protection device, and/or boost inductors. Please note that number of phase legs in the Input Module may be different from the number of phases of the ac source. For example, a phase of the input sources may be coupled to multiple phase legs of the Input Module if needed. The Input Module may be controlled such that a proper voltage in the dc bus Vdc1 is established while the currents in the ac source have high quality through power factor correction or similar techniques. DC link switches are not shown in FIG. 3, and the block diagram in FIG. 3 roughly corresponds to the active configuration in power conversion mode (similar to the circuit with both SW1 and SW2 open in FIG. 2).

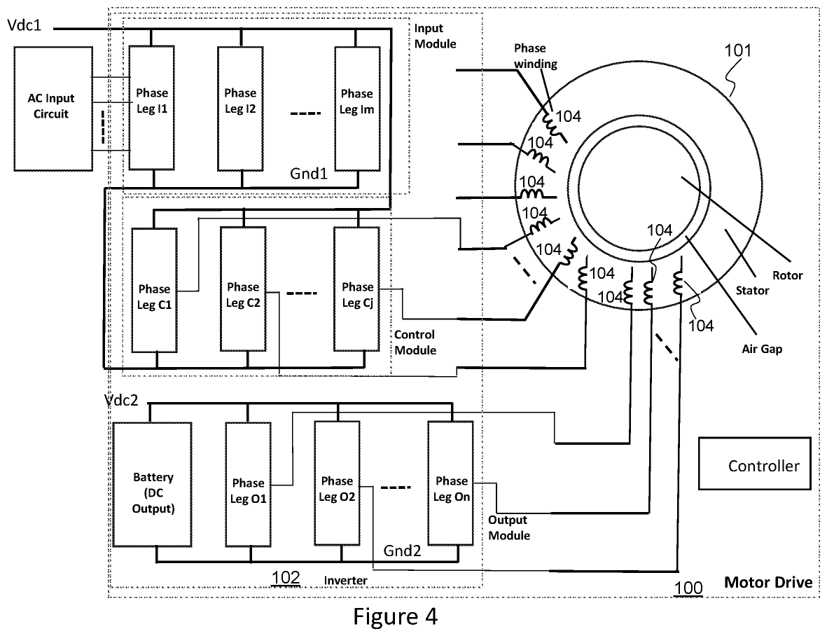

In FIG. 3, a phase leg in the Input Module is coupled to both the input ac source and an input winding 104 of the motor 101. This may cause significant power loss in the motor, especially when the magnetic path in the motor may be saturated in such an operation. Sometimes it is desirable to disconnect the phase windings from the Input Module during power conversion operation mode. FIG. 4 shows such a configuration, where the phase windings 104 are disconnected from the Input Module (by proper switching devices) in the power conversion mode. Now the inverter 101 is divided into three groups, and a new group called a Control Module consisting of Phase Legs C1 through Cj (with j being an positive integer, representing the number of phase legs in the Control Module) is established from the inverter 101, which converts the voltage of the dc link Vdc1 to proper currents or energy in the phase windings 104 coupled to the Control Module (control windings). Again, for the sake of brevity dc link switchs are not shown in FIG. 4, and the block diagram shown in FIG. 4 is basically the active configuration in power conversion mode. Comparing to FIG. 2, one more sets of dc link switches should be added to divide the inverter into three groups. Now the Control Module and the Output Module perform a similar dc-dc conversion function to the Input Module and Output Module in FIG. 2, so the voltage/current/power at the power sources may be properly controlled. Please note that the power flow can be bidirectional. Again, the ac source may be in the same equipment or different equipment where the inverter is located. For example, the ac source, with or without all or part of the AC Input Circuit, may be in a ground charging station, while the rest of the system may be in a vehicle.

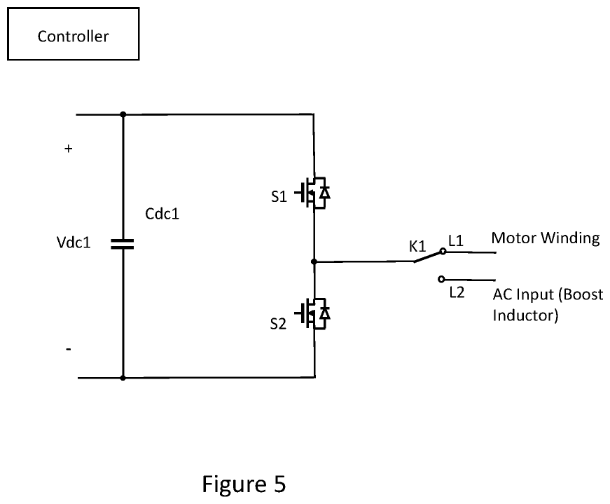

FIG. 5 shows a circuit diagram of a phase leg with a switch device K1. Here S1 and S2 form a phase leg coupled to a dc link capacitor Cdc1, and the switch device K1 is a double throw configuration, so the phase leg may be coupled to an ac source or a winding of the motor. This configuration can be used in the Input Module in FIG. 4. The double-throw switch may be a mechanical switch or an electronic switch where power semiconductor devices such as MOSFETs or IGBTs can be used. The switch can be manually operated or electrically controlled. Also, this double-throw switch can be used to configure the connection of other components in the system. For example, the dc rail Vdc2 in FIG. 4 may be connected to Vdc1 in motor drive mode and to the dc output in power conversion mode. Of course, other types of switch devices, or a combination of different switch devices may be used instead if desired.

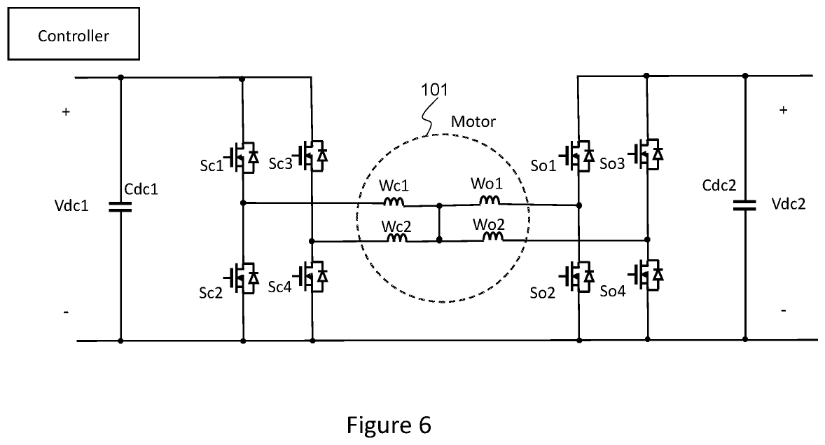

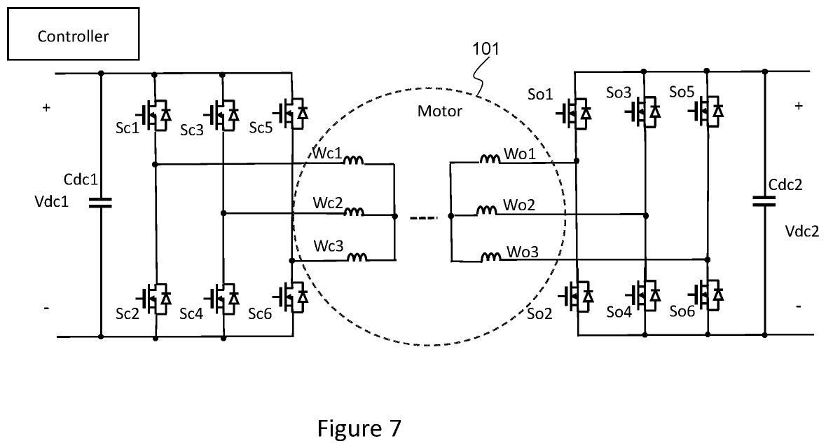

The essence of the above described technology is to reconfigure a motor drive system by dividing the power switches of the inverter and the windings of the motor into different groups in power conversion mode through dc link switches, so that different system functions such as a power conversion may be accomplished. FIG. 6 illustrates a simplified block diagram in a power conversion mode to illustrate the principle of power conversion mode operation. The inverter is divided into two groups in the power conversion mode, where power switches Sc1 through Sc4 form the first group with 2 phase legs in it, and power switchs Sol through So4 form the second group with also two phase legs in it. The number of phase legs in a group can change and should be selected according to system needs, and having two legs in a group here is just an example. As the windings in a motor are magnetically coupled, the windings Wc1, Wc2, Wo1 and Wo2 in FIG. 6 (which are phase windings 104 in motor 101 in previous figures) are also magnetically coupled. Usually, windings in a motor are connected together in a Y-connection pattern, as is shown in FIG. 6. By controlling the power switches Sc1 through Sc4 and Sol through So4, the currents in windings Wc1, Wc2, Wo1, Wo2 may be dc or ac, or a combination of ac and dc. When ac currents are used, it may be desirable to generate a rotating magnetic field inside the motor with the winding currents, in such case it is desirable that a group of windings has at least 3 windings distributed evenly in space inside the motor. FIG. 7 shows such a configuration, in which Sc1 through Sc6 form the first group (coupled to a group of phase windings Wc1 through Wc3), and Sol through So6 form the second group (coupled to a group of phase windings Wo1 through Wo3). Different groups may also be electrically isolated as is shown in FIG. 7. If needed, more groups can be added to have more output or input ports if necessary.

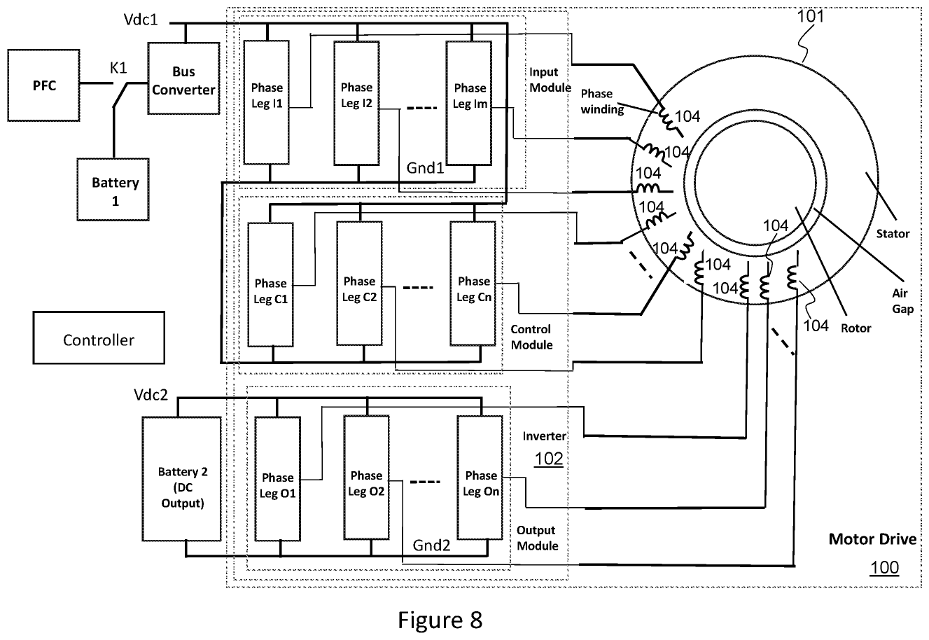

As discussed earlier, the system in FIG. 6 and FIG. 7 can be controlled to perform buck, boost or buck-boost functions, that is Vdc1 may be higher than, lower than or equal to Vdc2. However, sometimes it may be desirable to perform part of the voltage shifting function with a dedicate dc-dc power converter. FIG. 8 shows such a configuration, in which a double-throw switch K1 selects the input from a power factor correction converter (PFC) or a battery, and a bus converter produces a voltage suitable for the components in the motor drive system. DC link switches are omitted, so FIG. 8 shows just the block diagram of the active circuit in power conversion mode. Again, as in previous discussion, the negative dc rails of Gnd1 and Gnd2 may be isolated or shorted as system requires.

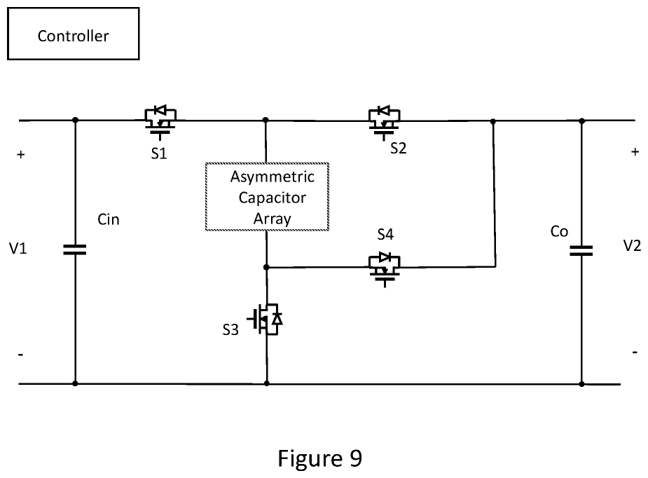

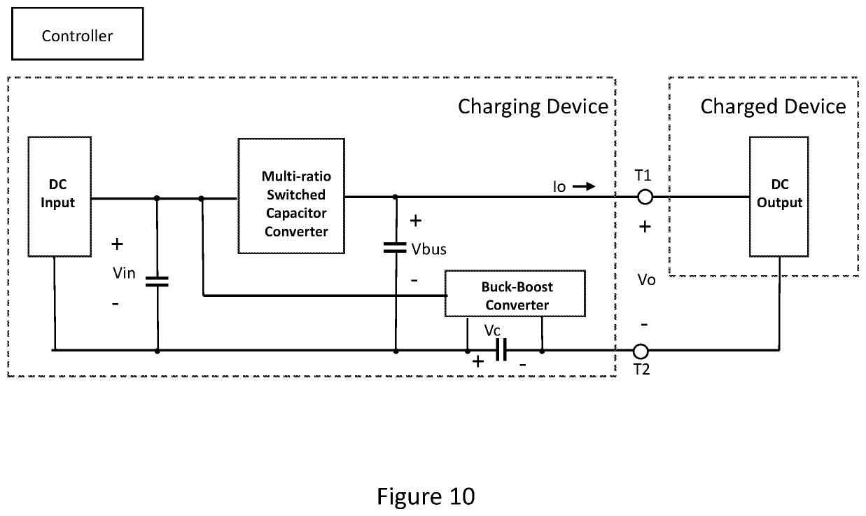

There are different technologies for the bus converter, and one of them is a multi-ratio switched capacitor converter as is shown in FIG. 9. The asymmetric capacitor array, presented in U.S. patent Ser. No. 11/631,998 “High Performance Wireless Power Transfer and Power Conversion Technologies”, is a controlled switch-capacitor network, which allows multiple ratios of Vo/Vin to be achieved efficiently, i.e. this bus converter allows its output to be roughly adjusted. If a fine control of the output voltage is needed, a buck-boost converter can be connected in series with the bus converter, as is shown in FIG. 10. The input of the multi-ratio switched-capacitor converter, used as the bus converter, is shown in parallel with the input of the buck-boost converter, but the output of the bus converter is in series with the output of the buck-boost converter. As a result, the output voltage (Vc) of the buck-boost converter is added to the output voltage (Vbus) of the bus converter, and fills the gap between the needed voltage at the load and the output voltage of the bus converter. The input of the buck-boost converter may also be the output or any middle point of the bus converter (with the input connection shown in the figure as an example), or any other suitable voltage source. Since now the buck-boost converter only processes a small portion of the output power, it can work at higher switching frequency, and can control the output voltage Vo or output current Io to have a fast response and a fast changing component. As one example, Vo or Io may have a controlled pulsing or ac component within certain frequency range. The pulsing or ac component in Io (or Vo) also induces an ac or pulsing component at the voltage (or current) of the DC output, and thus the impedance of the dc output may be measured at a given frequency or frequency range. This will help to determine the operation characteristics or heath state of the DC output. This is especially helpful if the DC output is a battery. Similarly, through controlling a pulsing or ac component in Vo or Io, impedance of the dc input at one or more frequency points may be measured, and can be used to determine the operational characteristics or health state of the DC input, which may be a battery. The controller should be configured to control the system according to application needs. Since the dc-dc converter is bidirectional, its input current and output current may be negative, and may have high frequency components when operating in a high-frequency mode. In such a high-frequency mode, a closed control loop may be used to regulate the targeted current in addition to routine DC current control, and a high-frequency reference with the right waveform and amplitude may be added to its reference. However, to avoid disturbance and oscillation in the current when power flow changes direction, a dc bias component with a proper polarity may be added to the current reference so that the combined current flows only in one direction during the high-frequency mode. The amplitude of the current reference should be selected such that the components in the system are within the stress limit, and the switching frequency may be increased and the control bandwidth be enlarged accordingly in the high-frequency mode.

Therefore, the configuration shown in FIG. 10 may be used in different applications, especially to charge a battery or get power from a battery. Please note that the power flow in the system shown in FIG. 10 may be bidirectional when needed.

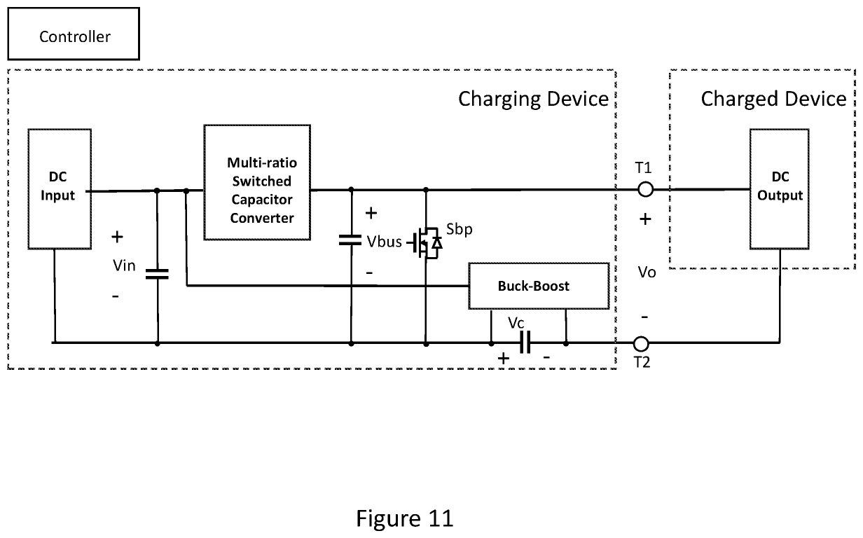

If a low output is required, sometimes it may be desired to bypass the output of the bus converter. FIG. 11 shows an example, where the bus converter's output is bypassed with a switch Sbp. If the power switches in the bus converter are turned off and Sbp is turned on, the output power will be produced only by the buck-boost converter, so very low voltage can be obtained with proper control of the buck-boost converter.

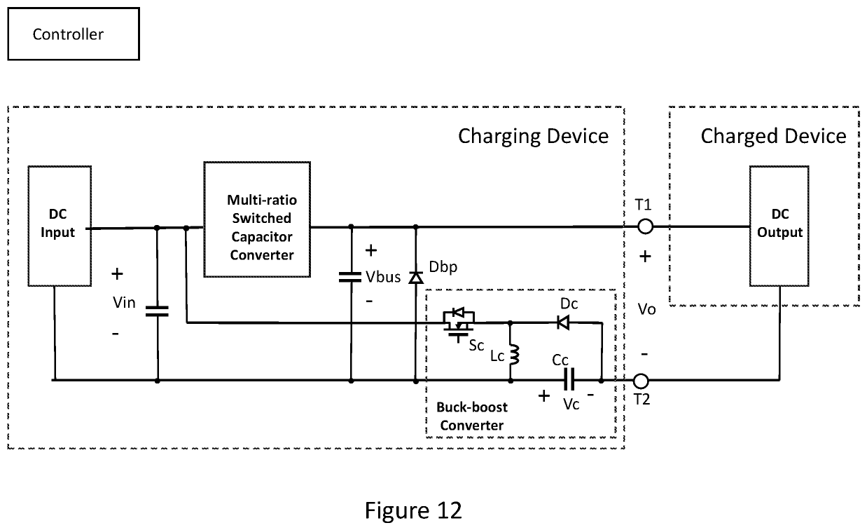

FIG. 12 shows an example implementation of the system in FIG. 11. Now the bypass switch is implemented as a diode Dbus, and a single-switch topology is used to implement the buck-boost converter comprising Sc, Dc, Lc and Cc. This results in a low cost design. Please note that the bypass diode Dbus and/or Dc may be implemented as a synchronous rectifier with an active switch such as a MOSFET or IGBT. The switching devices Sc, and Dc, as well as inductor Lc, in the buck-boost converter may also be reconfigured from a motor drive.

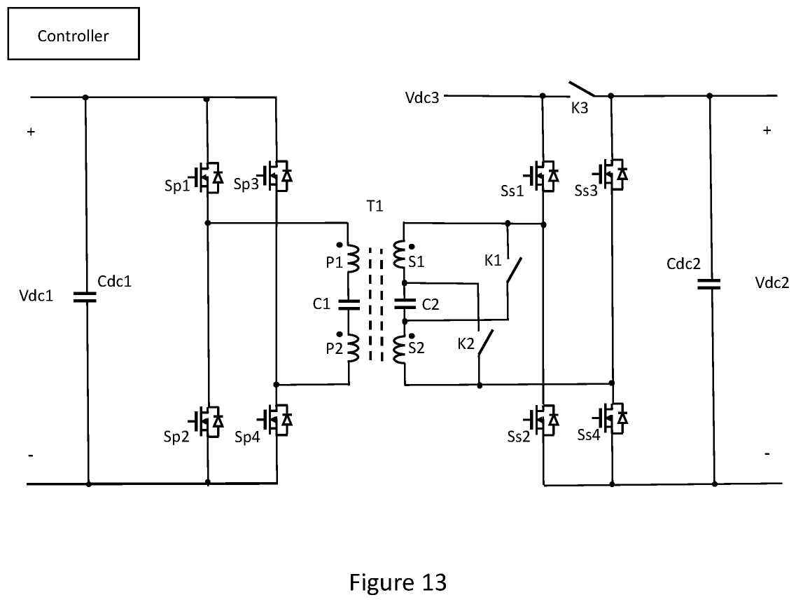

The principle of reconfiguring power components can also be applied to isolated power conversion systems. FIG. 13 shows an isolated full-bridge power converter with a switch matrix comprising of switches K1, K2 and K3, which may be mechanical switches such as relay, contactor, breaker, or knife switches, or electronic counterparts such as MOSFETs or IGBTs. The switch matrix is configured to change the secondary side circuit into a non-isolated dc-dc power converter when the switches K1 and K2 are closed and K3 is open in a backup operation mode, during which the primary switch network comprising primary switches Sp1 through Sp4 is disabled, and the transformer T1 consisting primary windings P1 and P2 and secondary windings S1 and S2, which are magnetically coupled, operates as an inductor with coupled windings. The arrangement of these windings and optional resonant capacitors C1 and C2 may have different alternatives and should be designed according to system requirements. In the backup operation mode, windings S1 and S2 are in parallel and together with the secondary switch network comprising of Ss1 through Ss4 form a 4-switch buck-boost converter. With K3 open in the backup operation mode, Vdc2 may be equal to, higher than or lower than Vdc3, and the buck-boost converter may operate in bucking mode with Ss1 closed and Ss2 open while other two switches in PWM control, boosting mode with Ss3 closed and Ss4 open while other two switches in PWM control, or buck-boosting mode with all four switches in PWM control. The three operating modes can be configured to have high operating efficiency and/or low current ripple in the inductor, output ort or input port. Since the flux contributed by windings S1 and S2 is additional, the transformer T1 needs to be designed properly to avoid magnetic saturation in the intended operation range. The switching frequency in the backup operation mode should be selected to be a proper value or in a proper range such that the capacitors C1 and C2 presents enough impedance to reduce performance degradation, or they may be opened by a switch during the backup operation mode.

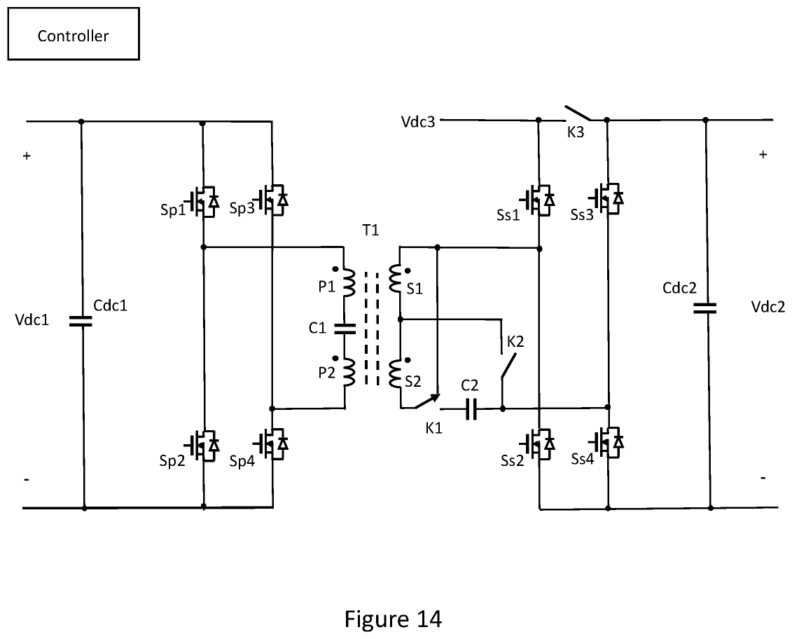

If very high current is required during the backup operation mode, it may be desired that the flux contributed by winding S1 and winding S2 be subtractive to each other to avoid magnetic saturation in the transformer T1. FIG. 14 shows an example which is otherwise similar to the power system in FIG. 13. Switch K1 is a single-pole double-throw arrangement, and together with switch K2 it puts S1 and S2 into reverse-parallel in backup operation mode, i.e. terminals of these two windings with different polarities are connected together, so the flux contributed by these two windings tends to cancel each other in the backup operation mode.

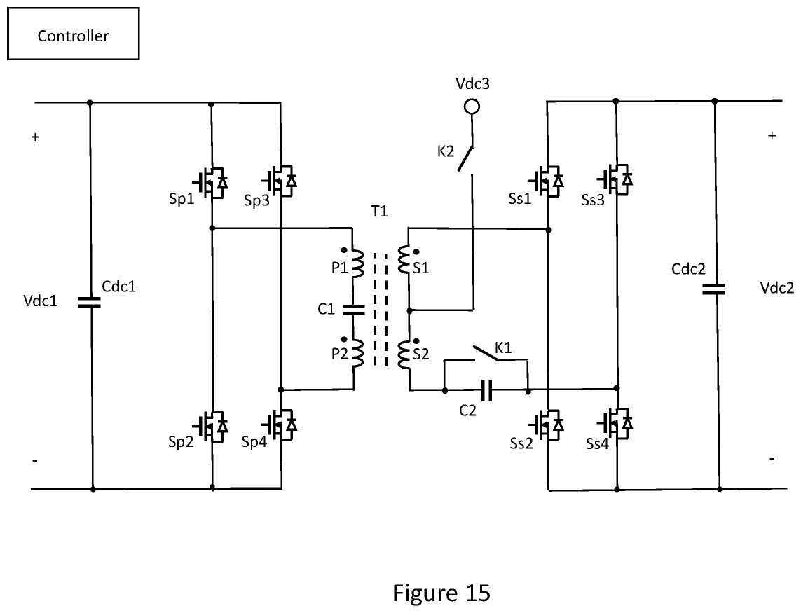

Another example to reconfigure the secondary side of an isolated power converter is shown in FIG. 15, where the non-isolated power converter can be configured as a buck converter with two channels, and the inductors in these two channels are magnetically inverse-coupled, while the switching clocks (switching actions) for these two channels may be interleaved to reduce the current ripple at the input and output port. The core and windings of the transformer T1 should be configured to give proper coupling in both normal operation and backup operation modes. Since the dc flux contributed by S1 and S2 approximately cancels each other in backup operation mode, magnetic saturation can be avoided, and high output current can be achieved. K1 may be removed or configured to connect S1 and S2 in reverse-paralleled (different polarity points are connected) if only one channel is needed in backup operation mode.

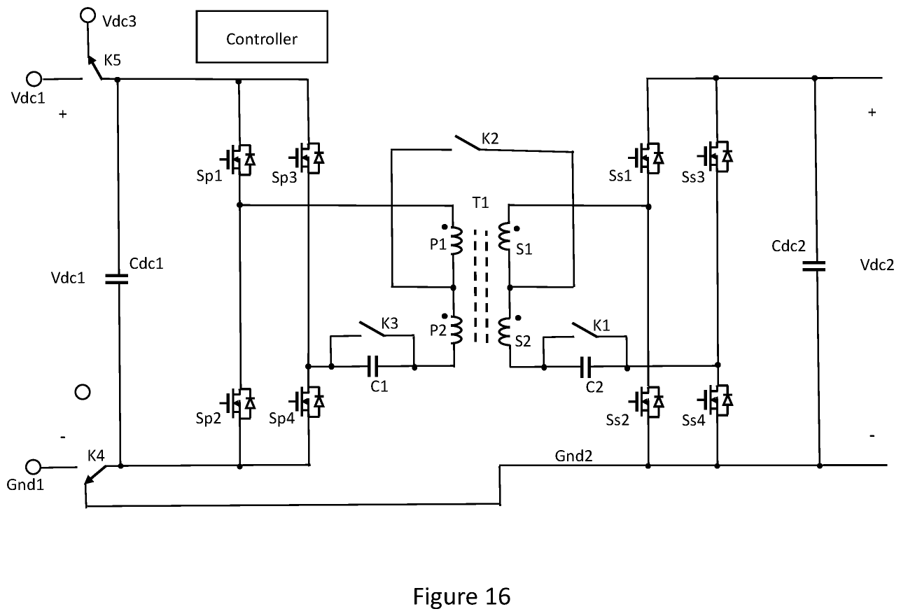

If buck-boost operation is needed in subtractive flux arrangement, the primary switch network and windings may be used also to provide part of the power conversion, with an example shown in FIG. 16. Now the primary and secondary windings are connected in the backup operation mode, and the two dc rails in the primary switch network are reconfigured by two double-throw switches K4 and K5 if needed. Again, if only one channel is needed, K1 and K3 may be removed or changed to connect the primary (and/or secondary) windings in reverse-parallel as discussed before. Please note that since P1 and S1 are connected in reverse connection, the flux contributed by P1 and S1 tends to cancel out in backup operation mode even when K1 and K3 are removed, alleviating any magnetic saturation issue.

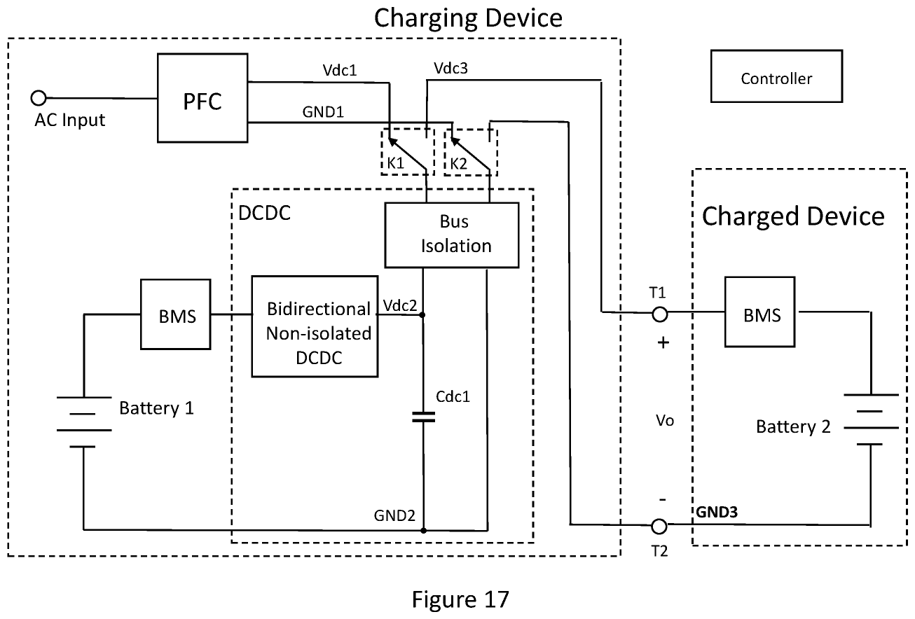

In previous discussion, full-bridge topologies are used as examples in the primary and secondary switch network. Other topologies, such as half-bridge, forward, flyback, class-e etc, may also be used if necessary and the switch matrix may be adjusted to achieve similar performance. The discussed technology can be used for different applications according to different system requirements. FIG. 17 shows an example for charging applications. A charging device may have an ac input, which is converted to an input dc voltage bus Vdc1 through a PFC converter, and the PFC converter may be bidirectional or unidirectional in single-phase, three-phase or any suitable configuration. Vdc1 is coupled to an isolated dc-dc converter Bus Isolation which is coupled to a first battery pack. The dc-dc converter may be a two-stage dc-dc converter, consisting a non-isolated power converter and an isolated bus converter. The charging device can be configured to charging a second battery pack in a charged device. The isolated bus converter may be similar to the dc-dc converter discussed above in topology, but controlled in fixed duty cycle thus providing voltage scaling. Of course, the bus converter and/or the non-isolated power converter may be combined into a single-stage dc-dc converter with frequency or duty-cycle control if needed, and reconfigured as discussed before. The two double-throw switches K1 and K2 (which may be combined into a double-pole double-throw conductor) are used to reconfigure the dc rail of the primary switch network of the bus converter. In the normal operation mode, the primary side of the bus converter is connected to the input dc rail Vdc1, and the energy is transferred between the ac input and the first battery pack, while in the backup operation mode, the primary side of the bus converter is connected to the second battery pack, and energy is transferred between the first battery pack Battery 1 and the second battery pack Battery 2. One advantage is that the ground of Battery 1 and Battery 2 can be isolated. Also, K1 and/or K2 may be combined with a pre-charging switch in the PFC converter to reduce cost, as the pre-charging function in the PFC converter and the charging function between the two battery packs may not happen at the same time. Also K1 and/or K2 may be single-throw switches if the PFC converter is not energized when the charging function between battery packs is active.

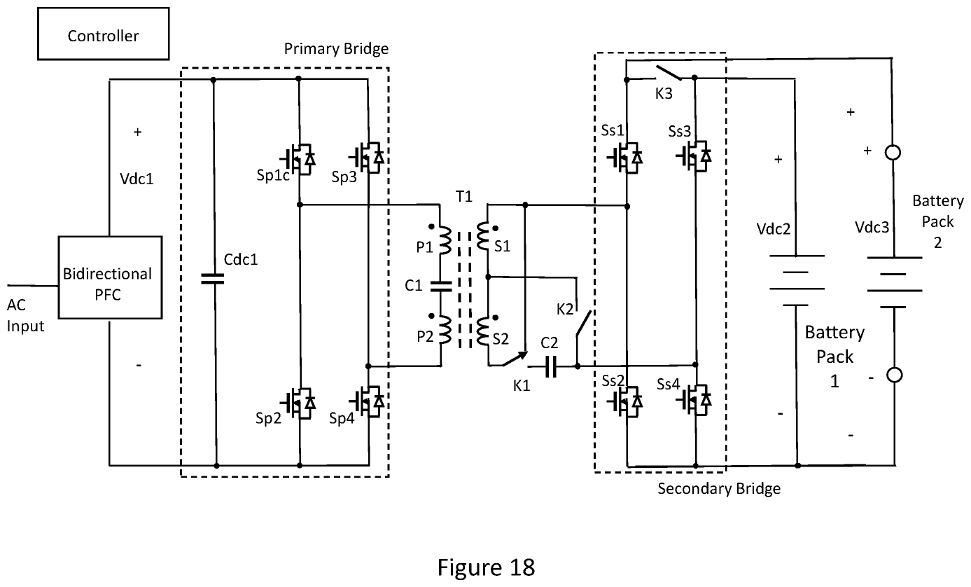

Another example is shown in FIG. 18, which is similar to FIG. 17 but the two battery packs are not isolated and a single-stage dc-dc converter is presented. Switches K1, K2 and K3 can reconfigure the secondary side circuit in buck-up operation mode.

It should be noted that the transformers and power switches in FIGS. 13-18 may also be reconfigured from a motor drive system. In this disclosure, switches are used to reconfigure a motor drive system or power converter into a different power conversion device, thus saving cost, size and weight of the related power system. Usually more than one switch are required to perform the reconfiguration, but please note that different switches may be combined into a physical component, such as a multi-pole contactor, multi-pole relay or switch network.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A device comprising:
a plurality of phase legs configured to be coupled to a motor and arranged into at least two groups, wherein each group has more than one phase leg, and each phase leg comprises at least two power switches coupled between a positive dc rail and a negative dc rail of the group, and wherein the motor comprises:
a stator and a rotor configured to be magnetically coupled through an air gap; and
a plurality of phase windings distributed along a perimeter of the stator, wherein each of the plurality of phase windings is coupled to one of the plurality of phase legs,
a first dc link switch placed between the dc rails of a group and the dc rails of another group; and
a controller configured to close the first dc link switch for the device to operate in a motor drive mode, or open the first dc link switch for the device to operate in a power conversion mode.

2. The device of claim 1, wherein:
the phase windings coupled to one of the groups are electrically isolated from the phase windings coupled to a different group.

3. The device of claim 1, wherein:
a second dc link switch is placed between the dc rails of two of the groups, and the first and second dc link switches are configured to separate the positive dc rails and negative dc rails of the groups in the power conversion mode to facilitate isolated power conversion.

4. The device of claim 3, wherein:
the phase windings coupled to the phase legs in one of the groups are configured to generate a rotating magnetic field inside the motor when currents flow through the said phase windings through controlling the said phase legs in the power conversion mode.

5. The device of claim 1, wherein:
the first dc link switch is uni-directional.

6. The device of claim 1, wherein:
the plurality of phase legs are configured to perform buck, boost or buck boost functions in the power conversion mode.

7. A method comprising:
configuring a stator and a rotor of a motor to be magnetically coupled through an air gap;
distributing a plurality of phase windings along a perimeter of the stator;
arranging a plurality of phase legs of an inverter into at least two groups, wherein each group has more than one phase leg, and each phase leg comprises at least two power switches coupled between a positive dc rail and a negative dc rail of the group and configured to be coupled to one of plurality of phase windings;
placing a first dc link switch between the dc rails of a group and the dc rails of another group; and
configuring a controller to close the first dc link switch for the inverter and the motor to operate in a motor drive mode, or open the first dc link switch for the motor and the inverter to operate in a power conversion mode.

8. The method of claim 7, further comprising:
placing a second dc link switch between the dc rails of two of the groups, and the first and second dc link switches are configured to separate the positive dc rails and negative dc rails of the groups in the power conversion mode to facilitate isolated power conversion.

9. The method of claim 8, further comprising:
configuring the phase windings coupled to the phase legs of one group and controlling currents flowing through the said phase windings through controlling the said phase legs to generate a rotating magnetic field inside the motor in the power conversion mode.

10. The method of claim 9, further comprising:
selecting a speed of the rotating magnetic field to reduce a power loss.

11. The method of claim 7, further comprising:
operating at least two phase legs in one of the groups with a phase shift in switching clock in the power conversion mode.

12. A system comprising:
a motor comprising:
a stator and a rotor configured to be magnetically coupled through an air gap; and
a plurality of phase windings distributed along a perimeter of the stator;
a plurality of phase legs arranged into at least two groups, wherein each group has more than one phase leg, and each phase leg comprises at least two power switches coupled between a positive dc rail and a negative dc rail of the group and coupled also to one of the plurality of phase windings;
a first dc link switch placed between the dc rails of a group and the dc rails of another group; and
a controller configured to close the first dc link switch for the system to operate in a motor drive mode, or open the first dc link switch for the system to operate in a power conversion mode.

13. The system of claim 12, wherein:
a second dc link switch is placed between the dc rails of two of the groups, and the first and second dc link switches are configured to separate the positive dc rails and negative dc rails of the groups in the power conversion mode to facilitate isolated power conversion.

14. The system of claim 13, wherein:
the phase windings coupled to the phase legs in one of the groups are configured to generate a rotating magnetic field inside the motor when currents flow through the said phase windings through controlling the said phase legs in the power conversion mode.

15. The system of claim 14, wherein:
a speed of the rotating magnetic field is selected to reduce a power loss.

16. The system of claim 15, wherein:
a plurality of wound windings is located in the rotor and is configured to conduct no current in the power conversion mode.

17. The system of claim 12, wherein:
the phase legs in one of the groups are coupled to an ac input circuit in the power conversion mode.

18. The system of claim 17, wherein:
the phase legs in the said group are disconnected from the phase windings of the motor in the power conversion mode.

19. The system of claim 18, wherein:
the said group performs power factor correction function and a different group coupled to the same dc rails as the said group is configured to control dc-dc power conversion in the power conversion mode.

20. The system of claim 12, wherein:
the phase legs coupled to one of the groups are electrically isolated from the phase windings coupled to the rest of the groups.
